(19) United States
(12) Patent Application Publication
(10) Pub. No.: US 2026/0331331 A1
(43) Pub. Date: Oct. 22, 2026

(54) TAPE-WRAPPED INSULATED WIRE AND COIL

(71) Applicant: TOTOKU INC., Tokyo (JP)

(72) Inventors: Tadashi YAMAGUCHI, Ueda-shi (JP); Shigeo HAYASHI, Ueda-shi (JP)

(73) Assignee: TOTOKU INC., Tokyo (JP)

(21) Appl. No.: 19/695,232

(22) Filed: Jun. 2, 2026

Related U.S. Application Data
(63) Continuation-in-part of application No. PCT/JP2024/032862, filed on Sep. 13, 2024.

(30) Foreign Application Priority Data
Dec. 5, 2023 (JP) 2023-205248

(51) Int. Cl. H01B 7/02; H01F 27/28; H01F 27/32

(52) U.S. Cl. CPC H01B 7/0258; H01B 7/0225; H01F 27/2823; H01F 27/323; H01F 27/325

(57) ABSTRACT

A tape-wrapped insulated wire includes a conductor and an insulating coating provided around the conductor. The insulating coating includes two to five insulating layers formed by overlap-winding respective insulating tapes. When the insulating coating includes two insulating layers, the sum of winding counts of the insulating layers is no greater than a sum of integer components of the winding counts plus 1. When the insulating coating includes three insulating layers, the sum is no greater than the sum of the integer components plus 1.5. When the insulating coating includes four or five insulating layers, the sum is no greater than the sum of the integer components plus 2. In each case, each integer component is in a range of 1 to 4. A coil is formed by winding the tape-wrapped insulated wire.

### CROSS-REFERENCE TO RELATED APPLICATIONS

This application is a continuation-in-part of International Application No. PCT/JP2024/032862, filed Sep. 13, 2024, which designated the United States and claims priority to Japanese Patent Application No. 2023-205248, filed Dec. 5, 2023. The entire contents of each of the foregoing applications are incorporated herein by reference.

### TECHNICAL FIELD

The present invention relates to a tape-wrapped insulated wire and a coil used for a coil of an electronic component such as a power transformer, and more particularly relates to a tape-wrapped insulated wire that can achieve an equivalent or higher electrical breakdown voltage even when the thickness of the insulating coating is the same, or can achieve an equivalent or higher electrical breakdown voltage even when the thickness of the insulating coating is reduced to make the insulated wire thinner, and to a coil formed of the tape-wrapped insulated wire.

### BACKGROUND ART

In electronic components such as transformers, inductors, and choke coils, three-layer insulated wires constituting reinforced insulation under safety standards such as IEC may be used in order to increase the space factor (for example, Patent Literature 1).

Patent Literature 1 provides a multilayer insulated wire in which an insulating layer is formed of three extruded coating layers and which satisfies IEC standards in solderability, heat resistance, interlayer peelability, and electrical insulating property even when the thickness of the insulating layer is reduced. In this multilayer insulated wire, the first insulating layer is formed of a polyamide resin having high mechanical strength and softening temperature, so that a crushing phenomenon of the insulating layer caused by winding tension during coil processing or by heat generation of the conductor during use of the coil does not extend to the conductor surface; therefore, even when the total thickness of the three extruded coating layers is set to 100 μm or less, the space factor of the coil can be increased when the multilayer insulated wire is used as a coil winding.

### PRIOR ART DOCUMENTS

### Patent Literature

Patent Literature 1: Japanese Laid-Open Patent Application Publication No. H6-139829

### SUMMARY OF INVENTION

### Technical Problem

In recent years, further improvement of efficiency and miniaturization through further increase of the space factor of coil windings of transformers has been desired. However, in the conventional three extruded coating layers described above, the coating thickness of one layer is limited to about 30 μm, and it has been difficult to further reduce the coating thickness to increase the space factor. On the other hand, tape-wrapped insulating coatings in which an insulating tape is wound in place of the extruded coating layers have also been used, but due to the coating strength and thickness limited by the tape material, a tape thickness of about 10 μm has been the limit. However, with a thin tape, the insulating performance could not be sufficiently satisfied. In such conventional insulated wires for coil windings, it has been difficult to reduce the thickness while ensuring a high withstand voltage, and miniaturization of the coil with an increased space factor has not been sufficiently realized.

The present invention has been made to solve the problem described above, and an object thereof is to provide a tape-wrapped insulated wire that can achieve an equivalent or higher electrical breakdown voltage even when the thickness of the insulating coating is the same, or can achieve an equivalent or higher electrical breakdown voltage even when the thickness of the insulating coating is reduced to make the insulated wire thinner, and a coil formed of the tape-wrapped insulated wire.

### Solution to Problem

(1) A tape-wrapped insulated wire according to the present invention is an insulated wire having a conductor and an insulating coating provided on an outer periphery of the conductor, wherein the insulating coating is composed of a plurality of insulating layers overlap-wound with two to five insulating tapes. When the insulating coating includes two individual insulating layers each overlap-wound with a respective one of the insulating tapes, the sum of the winding counts of the individual insulating layers is no greater than a total number obtained by adding 1 to the sum of integer parts of the winding counts of the individual insulating layers. When the insulating coating includes three individual insulating layers each overlap-wound with a respective one of the insulating tapes, the sum of the winding counts of the individual insulating layers is no greater than a total number obtained by adding 1.5 to the sum of the integer parts of the winding counts of the individual insulating layers. When the insulating coating includes four or five individual insulating layers each overlap-wound with a respective one of the insulating tapes, the sum of the winding counts of the individual insulating layers is no greater than a total number obtained by adding 2 to the sum of the integer parts of the winding counts of the individual insulating layers. In any of the cases where the individual insulating layers are two to five layers, the integer part of the winding count is in a range of 1 to 4.

According to this invention, the insulating coating provided on the outer periphery of the conductor is composed of a plurality of insulating layers overlap-wound with two to five insulating tapes. When the number of individual insulating layers is two, the sum of the winding counts of the individual insulating layers is no greater than a total number obtained by adding 1 to the sum of the integer parts (in the range of 1 to 4) of the winding counts of the individual insulating layers. When the number of individual insulating layers is three, the sum is no greater than a total number obtained by adding 1.5 to the sum of the integer parts (in the range of 1 to 4) of the winding counts of the individual insulating layers. When the number of individual insulating layers is four or five, the sum is no greater than a total number obtained by adding 2 to the sum of the integer parts (in the range of 1 to 4) of the winding counts of the individual insulating layers. Accordingly, the sum of the fractional parts, which are fractions of overlapping integer portions of turns when the individual insulating tapes are overlap-wound, can be set to 1.0 or less, 1.5 or less, or 2.0 or less, as appropriate. Thus, the total thickness of the insulating coating can be reduced, and the resulting insulated wire can be reduced in diameter. As a result, the space factor when a coil is manufactured can be improved.

Furthermore, since the sum of the fractional parts is controlled to 1.0 or less, 1.5 or less, or 2.0 or less as described above, the winding count of the overlapping integer portions of turns when each individual insulating tape is overlap-wound can be sufficiently secured. As a result, in comparison with a conventional insulated wire, the electrical breakdown voltage can be made equal to or higher even when the thickness of the insulating coating is the same, or the electrical breakdown voltage can be made equal to or higher even when the thickness of the insulating coating is reduced and the insulated wire is reduced in diameter. Further, controlling the fractional parts as described above is advantageous for diameter reduction, and from the standpoint of the substantial winding count composed of the sum of the integer parts (hereinafter referred to as the “minimum winding count”), the minimum winding count can be increased and the electrical breakdown voltage can be increased. Since the electrical breakdown voltage can be increased, if an electrical breakdown voltage at an equivalent level is sufficient, the insulating coating can be made thinner, thereby contributing to a reduction in the diameter of the insulated wire and an improvement in the space factor of the coil.

With such a tape-wrapped insulated wire, the electrical breakdown voltage can be maintained or improved, the wire is flexible and excellent in coil-winding properties, and the space factor can be increased to miniaturize the coil. In addition, since the insulating coating can be made thinner, the thermal resistance of the insulated wire is lowered and the heat dissipation is enhanced, so that the temperature of the insulated wire can be lowered.

(2) In the tape-wrapped insulated wire according to (1) of the present invention described above, in the case where the individual insulating layers each overlap-wound with the insulating tape in the insulating coating are two layers or three layers, when a winding count of a first insulating tape is expressed as s.α-fold winding, a winding count of a second insulating tape is expressed as t.β-fold winding, and a winding count of a third insulating tape is expressed as u.γ-fold winding, the sum of the integer parts is s+t when the insulating layers are two layers and is s+t+u when the insulating layers are three layers, the sum of the fractional parts is α+β when the insulating layers are two layers and is α+β+γ when the insulating layers are three layers, and the sum of the fractional parts is 1.0 or less. In this case, when the individual insulating layers are two layers, the third insulating tape described above is not used.

(3) In the tape-wrapped insulated wire according to (2) of the present invention described above, when the insulating tapes are two, the sum of the integer parts is 2 to 8, the sum of the fractional parts is 1.0 or less, and a total number is 2.0 to 9.0, and when the insulating tapes are three, the sum of the integer parts is 3 to 12, the sum of the fractional parts is 1.0 or less, and the total number is 3.0 to 13.0.

(4) In the tape-wrapped insulated wire according to (1) of the present invention described above, in the case where the individual insulating layers each overlap-wound with the insulating tape in the insulating coating are three layers, when a winding count of a first insulating tape is expressed as s.α-fold winding, a winding count of a second insulating tape is expressed as t.β-fold winding, and a winding count of a third insulating tape is expressed as u.γ-fold winding, the sum of the integer parts is s+t+u, the sum of the fractional parts is α+β+γ, and the sum of the fractional parts may be configured to be 1.5 or less.

(5) In the tape-wrapped insulated wire according to (1) of the present invention described above, in the case where the individual insulating layers each overlap-wound with the insulating tape in the insulating coating are four layers or five layers, when a winding count of a first insulating tape is expressed as s.α-fold winding, a winding count of a second insulating tape is expressed as t.β-fold winding, a winding count of a third insulating tape is expressed as u.γ-fold winding, a winding count of a fourth insulating tape is expressed as v.δ-fold winding, and a winding count of a fifth insulating tape is expressed as w.δ-fold winding, the sum of the integer parts is s+t+u+v when the insulating layers are four layers and is s+t+u+v+w when the insulating layers are five layers, the sum of the fractional parts is α+β+γ+δ when the insulating layers are four layers and is α+β+γ+8+s when the insulating layers are five layers, and the sum of the fractional parts is 2.0 or less. In this case, when the individual insulating layers are four layers, the fifth insulating tape described above is not used.

(6) In the tape-wrapped insulated wire according to (5) of the present invention described above, when the insulating tapes are four, the sum of the integer parts is 4 to 16, the sum of the fractional parts is 2.0 or less, and a total number is 4.0 to 18.0, and when the insulating tapes are five, the sum of the integer parts is 5 to 20, the sum of the fractional parts is 2.0 or less, and the total number is 5.0 to 22.0.

(7) In the tape-wrapped insulated wire according to (1) to (6) of the present invention described above, any one or more of the two to five insulating tapes may be provided with an adhesive layer. In this case, it is preferable that the thickness of the insulating tape is 0.002 to 0.1 mm.

(8) In the tape-wrapped insulated wire according to (1) to (6) of the present invention described above, it is preferable that the insulating tape wound last among the plurality of insulating tapes is provided with a fusion layer on its outwardly facing surface. In this case, it is preferable that the thickness of the insulating tape is 0.002 to 0.1 mm.

(9) A coil according to the present invention is obtained by winding the tape-wrapped insulated wire according to (1) to (6) of the present invention described above.

(10) A coil according to the present invention is obtained by winding the tape-wrapped insulated wire according to (7) of the present invention described above.

(11) A coil according to the present invention is obtained by winding the tape-wrapped insulated wire according to (8) of the present invention described above.

### Advantageous Effects of Invention

According to the tape-wrapped insulated wire according to the present invention, the total thickness of the insulating coating can be reduced, and the obtained insulated wire can be made thinner. As a result, the space factor when the coil is manufactured can be improved. In addition, even when the thickness of the insulating coating is the same, the electrical breakdown voltage can be made equivalent or higher; or even when the thickness of the insulating coating is reduced to make the insulated wire thinner, the electrical breakdown voltage can be made equivalent or higher. As a result, the electrical breakdown voltage can be maintained or improved, the wire is flexible and excellent in coil-winding properties, and the space factor can be increased to miniaturize the coil. In addition, since the insulating coating can be made thinner, the thermal resistance of the insulated wire is lowered and the heat dissipation is enhanced, so that the temperature of the insulated wire can be lowered.

According to the coil according to the present invention, since the coil is wound with the tape-wrapped insulated wire described above, the electrical breakdown voltage is maintained or improved, the productivity is high, and the coil can be a small-sized coil with a high space factor.

### BRIEF DESCRIPTION OF DRAWINGS

FIG. 1 is an external view of the tape-wrapped insulated wire according to the present invention.

FIGS. 2A and 2B show examples of cross-sectional views of the tape-wrapped insulated wire according to the present invention, in which FIG. 2A is an example overlap-wound with two insulating tapes, and FIG. 2B is an example overlap-wound with three insulating tapes.

FIGS. 3A and 3B show other examples of cross-sectional views of the tape-wrapped insulated wire according to the present invention, in which FIG. 3A is an example overlap-wound with four insulating tapes, and FIG. 3B is an example overlap-wound with five insulating tapes.

FIG. 4A is a cross-sectional view showing a form in which an adhesive layer is provided on an insulating tape, and FIG. 4B is a cross-sectional view showing a form in which a fusion layer is provided on an insulating tape.

FIG. 5 is an explanatory view of the coil according to the present invention.

FIG. 6 is a cross-sectional view of the tape-wrapped insulated wire of Example 1.

FIG. 7 is a cross-sectional view of the tape-wrapped insulated wire of Comparative Example 1.

FIG. 8 is a cross-sectional view of the tape-wrapped insulated wire of Example 2.

FIG. 9 is a cross-sectional view of the tape-wrapped insulated wire of Comparative Example 2.

### DESCRIPTION OF EMBODIMENTS

Hereinafter, the tape-wrapped insulated wire and the coil according to the present invention will be described with reference to the drawings. The present invention is not limited to the illustrated embodiments.

### [Tape-Wrapped Insulated Wire]

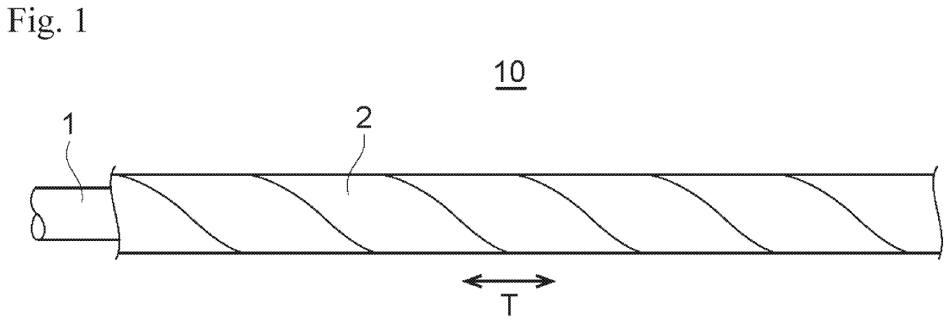

As shown in FIGS. 1 to 3, the tape-wrapped insulated wire 10 according to the present invention (hereinafter sometimes simply referred to as “insulated wire 10”) is an insulated wire 10 having a conductor 1 and an insulating coating 2 provided on an outer periphery of the conductor 1, and the insulating coating 2 is composed of a plurality of insulating layers (2a, 2b, 2c, 2d, 2e) overlap-wound with two to five insulating tapes (11, 12, 13, 14, 15). In this insulated wire 10, the insulating coating 2 is characterized in that: (1) when the individual insulating layers each overlap-wound with the insulating tape are two layers, the sum of the winding counts of the individual insulating layers is no greater than a total number obtained by adding 1 to the sum of the integer parts of the winding counts of the individual insulating layers; (2) when the individual insulating layers are three layers, the sum of the winding counts of the individual insulating layers is no greater than a total number obtained by adding 1.5 to the sum of the integer parts of the winding counts of the individual insulating layers; or (3) when the individual insulating layers are four or five layers, the sum of the winding counts of the individual insulating layers is no greater than a total number obtained by adding 2 to the sum of the integer parts of the winding counts of the individual insulating layers, and in any of the cases where the individual insulating layers are two to five layers, the integer part of the winding count is in the range of 1 to 4.

According to such a tape-wrapped insulated wire 10, the total thickness of the insulating coating 2 can be reduced, and the obtained insulated wire 10 can be made thinner. As a result, the space factor when the coil is manufactured can be improved. In addition, even when the thickness of the insulating coating 2 is the same, the electrical breakdown voltage can be made equivalent or higher; or even when the thickness of the insulating coating 2 is reduced to make the insulated wire 10 thinner, the electrical breakdown voltage can be made equivalent or higher. As a result, the electrical breakdown voltage can be maintained or improved, the wire is flexible and excellent in coil-winding properties, and the space factor can be increased to miniaturize the coil. In addition, since the insulating coating 2 can be made thinner, the thermal resistance of the insulated wire is lowered and the heat dissipation is enhanced, so that the temperature of the insulated wire 10 can be lowered.

Hereinafter, each component will be described.

### <Conductor>

As shown in FIGS. 1 to 3, the conductor 1 is not particularly limited as long as it is applied as a central conductor of the insulated wire 10, particularly the insulated wire 10 for a coil, and may be any kind of conductor regardless of material or twisting configuration. For example, the conductor 1 may be composed of a single strand extending in the longitudinal direction, may be composed of several strands twisted together, or may be configured as a litz wire. The strand is not particularly limited in kind as long as it is a good conductive metal, but preferable examples include good conductive metal conductors such as a copper wire, a copper alloy wire, an aluminum wire, an aluminum alloy wire, and a copper-aluminum composite wire, or those having a plating layer applied to their surfaces. From the viewpoint of use as a coil, a copper wire and a copper alloy wire are particularly preferable. Preferable plating layers include a solder plating layer, a tin plating layer, a gold plating layer, a silver plating layer, and a nickel plating layer. Furthermore, the “conductor” and the “strand” include those covered with an enamel layer or the like for insulation, oxidation prevention, or the like, within the scope of the conductor and the strand referred to in the present invention. The cross-sectional shape of the strand is also not particularly limited, and may be a wire material having a circular or substantially circular cross-sectional shape, or may be a rectangular shape.

The cross-sectional shape of the conductor 1 is also not particularly limited, and may be circular (including elliptical) or rectangular. In order to reduce the electrical resistance (alternating current resistance, conductor resistance) so that the conductor 1 can be preferably used for a coil, the cross-sectional size of the conductor 1 is desirably as large as possible; for example, the outer diameter of a circular strand may be about 0.05 to 5 mm. In the case of a rectangular strand, the short side may be about 0.3 to 2 mm and the long side may be about 0.5 to 5 mm. The cross-sectional size of these conductors 1 is appropriately selected depending on the application in which the coil is used, but the smaller this cross-sectional size, the higher the adhesion of the insulating coating 2 described later and the higher the positioning accuracy required.

### <Insulating Coating>

The insulating coating 2 is composed of a plurality of insulating layers (two to five insulating layers) overlap-wound with two to five insulating tapes and corresponding to the respective insulating tapes. Specifically, as shown in FIGS. 1 to 3, the insulating coating 2 is composed of two insulating layers (2a, 2b) overlap-wound with two insulating tapes (11, 12), three insulating layers (2a, 2b, 2c) overlap-wound with three insulating tapes (11, 12, 13), four insulating layers (2a, 2b, 2c, 2d) overlap-wound with four insulating tapes (11, 12, 13, 14), or five insulating layers (2a, 2b, 2c, 2d, 2e) overlap-wound with five insulating tapes (11, 12, 13, 14, 15) on the outer periphery of the conductor 1. The insulating coating 2 needs to have a thickness that ensures a prescribed electrical breakdown voltage, but it is desirable to make the insulating coating 2 as thin as possible while ensuring the prescribed electrical breakdown voltage. If the insulating coating 2 can be made thinner, there is an advantage that the insulated wire 10 can be made thinner and the space factor of the coil can be increased. The present invention has been completed by focusing on this point.

### (Number of Layers of Insulating Coating)

In a case where the insulating coating 2 includes individual insulating layers each overlap-wound with two or three insulating tapes and the individual insulating layers are two or three layers, respectively (for example, when two insulating tapes 11, 12 are used, the individual insulating layers are the first insulating layer 2a and the second insulating layer 2b, and when three insulating tapes 11, 12, 13 are used, the individual insulating layers are the first insulating layer 2a to the third insulating layer 2c), the sum of the winding counts of the individual insulating layers is configured to be no greater than the total number obtained by adding 1 to the sum of the integer parts of the winding counts of the individual insulating layers when the individual insulating layers are two layers, and is configured to be no greater than the total number obtained by adding 1.5 to the sum of the integer parts of the winding counts of the individual insulating layers when the individual insulating layers are three layers.

In a case where the insulating coating 2 includes individual insulating layers each overlap-wound with four or five insulating tapes and the individual insulating layers are four or five layers (for example, when four insulating tapes 11, 12, 13, 14 are used, the individual insulating layers are the first insulating layer 2a to the fourth insulating layer 2d, and when five insulating tapes 11, 12, 13, 14, 15 are used, the individual insulating layers are the first insulating layer 2a to the fifth insulating layer 2e), the sum of the winding counts of the individual insulating layers is configured to be no greater than the total number obtained by adding 2 to the sum of the integer parts of the winding counts of the individual insulating layers.

The reason why the treatment of the fractional part is divided between the case of two or three layers and the case of four or five layers is that, from the viewpoint of reducing the total thickness of the insulating coating to make the insulated wire thinner, and from the viewpoint of being able to achieve an equivalent or higher electrical breakdown voltage even when the thickness of the insulating coating is reduced or made the same, dividing into the case of two or three layers and the case of four or five layers does not make manufacturing complicated and is in line with reality. In any of the cases where the individual insulating layers are two or three layers and where the individual insulating layers are four or five layers, the integer part of the winding count of the individual insulating layers is preferably in the range of 1 to 4. Regarding this integer part, it may be in the range of 2 to 4, which does not include 1, as in Examples 1 to 5, 7, 8, and 10 described later, or the integer part of some layers may be 1 and the integer part of the remaining layers may be 2 to 4, as in Examples 9 and 11 described later. The reason why the integer part is set to 1 or more is that, unless the minimum winding count of each insulating layer is 1.0 or more and the integer part is 1 or more, the minimum electrical breakdown voltage cannot be ensured. The reason why the integer part is set to 4 or less is that, when the winding count of each insulating layer exceeds 5.0, the winding count becomes large and the counting of the integer part and the fractional part becomes difficult, and the complexity in the manufacturing process increases.

In this tape-wrapped insulated wire 10, since the sum of the fractional parts, which are remainders of the overlapping portions (integer parts) of turns when each of the insulating tapes is overlap-wound, is set to 0.0 or more and 1.0 or less, 1.5 or less, or 2.0 or less according to the number of insulating layers, the total thickness of the insulating coating 2 can be reduced, and the obtained insulated wire 10 can be reduced in diameter. As a result, the space factor when the coil is manufactured can be improved.

Furthermore, even when the thickness of the insulating coating 2 is the same as that of a conventional insulated wire, since the sum of the fractional parts is controlled as described above, the integer parts of overlapping turns when each of the insulating tapes is overlap-wound can be sufficiently secured. As a result, even when the thickness of the insulating coating 2 is the same as that of a conventional insulated wire, the electrical breakdown voltage can be made equivalent or higher. In addition, even when the thickness of the insulating coating 2 is reduced compared to a conventional insulated wire to reduce the diameter of the insulated wire 10, the integer parts of overlapping turns when each of the insulating tapes is overlap-wound can be sufficiently secured. As a result, the electrical breakdown voltage can be made equivalent or higher. Although setting the sum of the fractional parts to a small value acts advantageously for thinning the wire, from the viewpoint of the minimum winding count, the minimum winding count can be increased. As a result, the electrical breakdown voltage can be increased. Note that since the electrical breakdown voltage can be increased, if an equivalent level of electrical breakdown voltage is sufficient, the insulating coating 2 can be made thinner to contribute to thinning of the insulated wire 10 and to improvement of the space factor of the coil.

### (Conventional Mode of Layer Winding)

Here, the conventional tape-wrapped insulated wire prior to the development of the tape-wrapped insulated wire 10 according to the present invention will be described. Insulated wires having a tape wound around a round conductor, like the conventional tape-wrapped insulated wire, are required to be close to circular and to have a smooth surface, so that layer winding with many overlapping portions has been usually performed. In order to make the surface smooth, it has been considered desirable to make the overlap of the tape large, for example, to wind the tape such that the overlapping portion is 50% or more. Specifically, it has been performed to wind the tape with 1.5 to 2.0-fold winding, 2.5 to 3.0-fold winding, or 3.5 to 4.0-fold winding so that the fractional part is set to a large value to make the step generated at the tape end inconspicuous. Note that “1.5-fold winding” means that a tape is further wound on a 1-fold winding so that 50% of the 2-fold winding portion is wound, and “2-fold winding” means that a tape is further wound on a 1-fold winding so that 100% of the 2-fold winding portion is wound. Conventionally, a plurality of insulating layers (for example, the first to third insulating layers, or the first to fourth insulating layers) was formed by such layer winding. On the other hand, conventionally, layer windings such as 2.1-fold winding or 2.2-fold winding that slightly exceed an integer winding were not preferred because the tape end portion serving as the fractional part would become a slight 3-fold winding portion that easily becomes a step from the other 2-fold winding portion, and when such a step portion is narrow, the surface of the insulated wire becomes uneven.

However, as described in the section of the problem above, in order to meet the demand for thinning the insulated wire, the present inventors considered that the total thickness of the insulating layers could be reduced and the insulated wire could also be made thinner by setting the winding count of the insulating tape wound on the conductor not to a large overlapping portion of conventional insulating layers such as 1.5 to 2.0-fold winding, 2.5 to 3.0-fold winding, or 3.5 to 4.0-fold winding, but to a small overlapping portion such as 1.0 to 1.5-fold winding, 2.0 to 2.5-fold winding, 3.0 to 3.5-fold winding, or 4.0 to 4.5-fold winding so that the fractional part is reduced to 0.5 or less. Furthermore, since the insulating coating 2 is composed of a plurality of insulating layers, the present inventors considered that the wire could be made thinner by taking into consideration the winding counts of the multiple layers.

### (Mode of Overlap Winding in the Present Invention)

The mode of overlap winding of the insulating tape of the present invention based on the background described above has been described in the section of (Number of Layers of Insulating Coating) above, and more specifically, the present invention is characterized in that, as the insulating coating 2 configured by overlap winding two to five insulating tapes: (1) when the individual insulating layers each overlap-wound with the insulating tape are two layers, the sum of the winding counts of the individual insulating layers is no greater than the total number obtained by adding 1 to the sum of the integer parts of the winding counts of the individual insulating layers; (2) when the individual insulating layers each overlap-wound with the insulating tape are three layers, the sum of the winding counts of the individual insulating layers is no greater than the total number obtained by adding 1.5 to the sum of the integer parts of the winding counts of the individual insulating layers; or (3) when the individual insulating layers each overlap-wound with the insulating tape are four layers or five layers, the sum of the winding counts of the individual insulating layers is no greater than the total number obtained by adding 2 to the sum of the integer parts of the winding counts of the individual insulating layers.

First, as a narrower embodiment of the case where the insulating layers are two layers or three layers, the sum of the fractional parts may be configured to be 1.0 or less. In a case where the insulating coating 2 includes individual insulating layers each overlap-wound with the insulating tape and the individual insulating layers are two layers or three layers, as described in the Examples below, when the winding count of the first insulating layer 2a with the first insulating tape 11 is expressed as s.α-fold winding, the winding count of the second insulating layer 2b with the second insulating tape 12 is expressed as t.β-fold winding, and the winding count of the third insulating layer 2c with the third insulating tape 13 is expressed as u.γ-fold winding, the sum of the integer parts s, t, u is s+t in the case of two layers and is s+t+u in the case of three layers. The sum of the fractional parts α, β, γ is α+β in the case of two layers and is α+β+γ in the case of three layers. With this relationship, by setting the sum of the fractional parts to 1.0 or less in this narrower embodiment, the sum of the winding counts of the fractional parts that does not contribute to the minimum winding count (the substantial winding count composed of the sum of the integer parts) is reduced to 1.0 or less, so that the tape-wrapped insulated wire 10 can be made thinner. Note that the minimum winding count is the winding count of the sum of the integer parts on which the electrical breakdown voltage of the tape-wrapped insulated wire depends. Note that “1.0 or less” of the sum of the winding counts of the fractional parts includes 0.0. Note that “depends” means that the electrical breakdown voltage has a correlation with the integer part, and that the electrical breakdown voltage increases as the integer part increases.

In this narrower embodiment, when the insulating tapes are two, since the integer part of the winding count of each individual insulating layer is in the range of 1 to 4, the sum of the integer parts is 2 to 8, the sum of the fractional parts is 0.0 or more and 1.0 or less, and the total number thereof is 2.0 to 9.0. When the insulating tapes are three, since the integer part of the winding count of each individual insulating layer is in the range of 1 to 4, the sum of the integer parts is 3 to 12, the sum of the fractional parts is 0.0 or more and 1.0 or less, and the total number thereof is 3.0 to 13.0.

Next, the case of (2), where the insulating layers are four layers or five layers, will be described. As described in the Examples below, similarly to the case of two or three layers described above, in a case where the insulating coating 2 includes individual insulating layers each overlap-wound with the insulating tape and the individual insulating layers are four layers or five layers, when the winding count of the first insulating layer 2a with the first insulating tape 11 is expressed as s.α-fold winding, the winding count of the second insulating layer 2b with the second insulating tape 12 is expressed as t.β-fold winding, the winding count of the third insulating layer 2c with the third insulating tape 13 is expressed as u.γ-fold winding, the winding count of the fourth insulating layer with the fourth insulating tape is expressed as v.δ-fold winding, and the winding count of the fifth insulating layer with the fifth insulating tape is expressed as w.δ-fold winding, the sum of the integer parts s, t, u, v, w is s+t+u+v in the case of four layers and is s+t+u+v+w in the case of five layers. The sum of the fractional parts a, B, Y, 8, & is α+β+γ+δ in the case of four layers and is α+β+γ+8+& in the case of five layers. The sum of the fractional parts is configured to be 2.0 or less. With this relationship, in the case where the insulating layers are four layers or five layers, by setting the sum of the fractional parts to 2.0 or less, the sum of the winding counts of the fractional parts that does not contribute to the substantial winding count (the so-called minimum winding count) is reduced to 2.0 or less, so that the tape-wrapped insulated wire 10 can be made thinner. Note that “2.0 or less” of the sum of the winding counts of the fractional parts includes 0.0.

In this case, when the insulating tapes are four, the sum of the integer parts is 4 to 16, the sum of the fractional parts is 0.0 or more and 2.0 or less, and the total number thereof is 4.0 to 18.0. When the insulating tapes are five, the sum of the integer parts is 5 to 20, the sum of the fractional parts is 0.0 or more and 2.0 or less, and the total number thereof is 5.0 to 22.0.

With the tape-wrapped insulated wire 10 having such an insulating coating 2, the electrical breakdown voltage can be maintained or improved, the wire is flexible and excellent in coil-winding properties, and the space factor can be increased to miniaturize the coil. In addition, since the insulating coating 2 can be made thinner, the thermal resistance of the insulated wire is lowered and the heat dissipation is enhanced, so that the temperature of the insulated wire 10 can be lowered.

The fractional part will be described in detail. In the present invention, the case where the individual insulating layers each overlap-wound with the insulating tape are two layers, the case where they are three layers, and the case where they are four layers or five layers are distinguished. In the two-layer case, the sum of the fractional parts may be set to 0.0 or more and 1.0 or less, and each fractional part may be set to 0.0 or more and 0.5 or less. In the three-layer case, a narrower embodiment may set the sum of the fractional parts to 0.0 or more and 1.0 or less, in which case each fractional part may be set to 0.0 or more and 0.333 or less. In another three-layer embodiment, described in further detail below, the sum of the fractional parts may be set to 0.0 or more and 1.5 or less, in which case each fractional part may be set to 0.0 or more and 0.5 or less. In the four-layer case, the sum of the fractional parts may be set to 0.0 or more and 2.0 or less, and each fractional part may be set to 0.0 or more and 0.5 or less. In the five-layer case, the sum of the fractional parts may be set to 0.0 or more and 2.0 or less, and each fractional part may be set to 0.0 or more and 0.4 or less.

Looking at these modes (1) to (4), in the case of the individual insulating layers being three layers in (2), the winding count of the fractional part of each insulating layer must be 0.333 or less in order to keep the sum of the fractional parts within 1.0 or less, and from the viewpoint of manufacturing, the tolerance of the fractional part is smaller than in the other cases. In view of this, in the present invention, it is preferable that the sum of the fractional parts in the case of the individual insulating layers being three layers is changed from the original 0.0 or more and 1.0 or less to 0.0 or more and 1.5 or less. By doing so, the winding count of the fractional part of each insulating layer in the case of the individual insulating layers being three layers can be set to 0.0 or more and 0.5 or less, which can be made comparable to the other cases of (1), (3), and (4). Even when the sum of the fractional parts in the case of the individual insulating layers being three layers is set to 0.0 or more and 1.5 or less, the same effects as in the case of being set to 0.0 or more and 1.0 or less (the total thickness of the insulating layers can be reduced, the insulated wire can also be made thinner, the electrical breakdown voltage can be maintained or improved, the wire is flexible and excellent in coil-winding properties, and the space factor can be increased to miniaturize the coil) can be maintained. That is, an insulated wire 10 having a conductor 1 and an insulating coating 2 provided on the outer periphery of the conductor 1, in which the insulating coating 2 is composed of three insulating layers (2a, 2b, 2c) overlap-wound with three insulating tapes (11, 12, 13), is sufficient if the insulating coating 2 has individual insulating layers each overlap-wound with the insulating tape that are three layers, the sum of the winding counts of the individual insulating layers is no greater than the total number obtained by adding 1.5 to the sum of the integer parts of the winding counts of the individual insulating layers, and the integer part of the winding count is in the range of 1 to 4.

### (Insulating Tape)

The insulating tape is wound on the outer periphery of the conductor 1 in a plurality of layers. The term “plurality” in the present invention means two to five. The reason for setting the number of insulating tapes in the range of two to five is that, by using at least two insulating tapes, it is easy to ensure the necessary electrical breakdown voltage. The reason for setting the number of insulating tapes up to five is that, when there are six or more, the complexity in the manufacturing process increases, so that the manufacturing cost becomes high, and further enhancement of the effect is not easily obtained. Therefore, the present invention is described with a mode of winding two to five insulating tapes in layers.

The material of the insulating tape is not particularly limited, and for example, insulating resin materials such as a polyethylene resin, a polyester resin (PET, PEN, etc.), a polyimide resin, a polyamide resin, a polyamide-imide resin, a polyphenylene sulfide resin, and PEEK (polyetheretherketone) can be preferably applied. Among such resin materials, low dielectric constant fluorine-based resins such as PFA, ETFE, and FEP, which are used as dielectric materials, may be used, or resins such as a polyphenylene ether resin, polyolefin resins such as polypropylene, and polyester resins may be used.

The thickness of the insulating tape is not particularly limited as long as it is a thickness that allows the insulating coating 2 after layer winding with each of the plurality (two to five) of insulating tapes to ensure the necessary insulation withstand voltage. The thickness of each insulating tape may be, for example, about 0.002 to 0.1 mm. Regarding the thickness, it is preferable to select the thickness in consideration of how thick the insulating coating 2 is finally to be by layer winding the insulating tapes used, depending on how many insulating tapes are used and how many times the layer winding is performed. When the insulating tape is provided with the adhesive layer 5 or the fusion layer 6 described later, the thickness including the thickness of the adhesive layer 5 or the fusion layer 6 is the thickness of the insulating tape. The width of the insulating tape is also not particularly limited, but may be a width that allows layer winding on the outer periphery of the conductor 1 or on the already wound insulating tape; for example, the width is preferably 2 to 12 times the diameter of the conductor 1. The width of the insulating tape is usually preferably in the range of 0.4 to 50 mm. The two to five insulating tapes used may have the same thickness and width, or may be different. The winding pitch in layer winding is a winding pitch that can realize the layer winding form described later. The winding direction of each insulating tape is also not particularly limited, but it is preferable that the insulating tape be wound in the opposite direction to the adjacent insulating tape.

### (Adhesive Layer)

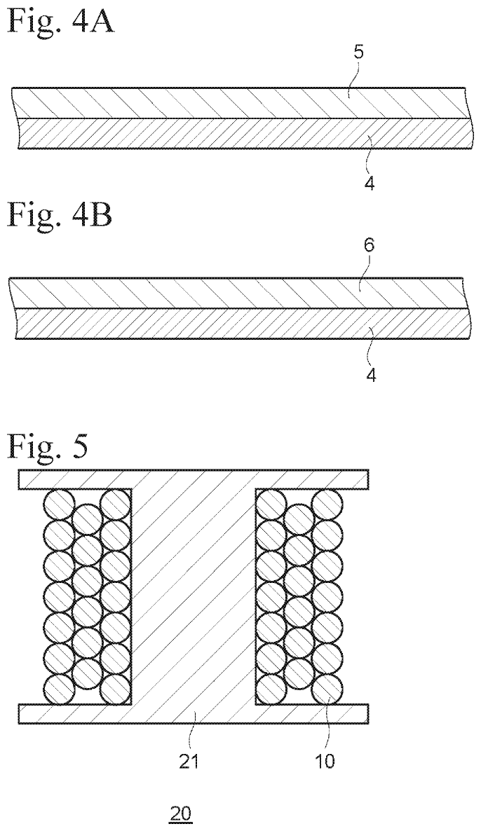

As shown in FIG. 4A, the adhesive layer 5 may be provided on any one or more of the first to fifth insulating tapes as necessary. “As necessary” means that the adhesive layer 5 may or may not be provided, that is, optional.

As the insulating tape provided with the adhesive layer 5, a resin tape 4 with the adhesive layer in which the adhesive layer 5 is provided on the resin tape 4 made of the materials described in the section of the materials of the insulating tape above is preferably used. The thickness of the adhesive layer 5 is also not particularly limited, but it is preferable that the thickness be 5 μm or less because the entire thickness becomes thick if too thick. The lower limit of the thickness of the adhesive layer is also not particularly limited, but may be, for example, 0.5 μm.

The adhesive layer 5 may be provided on one side or both sides of the insulating tape, and is not particularly limited, but is preferably provided on one side. The insulating tape may be wound with the side of the adhesive layer 5 provided on one side facing inward (the conductor side) or facing outward. In the first insulating tape 11 wound first among the plurality of insulating tapes, by winding with the side of the adhesive layer 5 provided on one side facing inward (the conductor side), there is an advantage that the insulating coating 2 can be brought into close contact with the conductor 1. On the other hand, in the first insulating tape 11 wound first, the side of the adhesive layer 5 provided on one side can also be wound facing outward (the side opposite to the conductor), which has an advantage that the insulating coating 2 is easily peeled off.

As another method, in order to make the insulating coating 2 easily peelable, the first insulating tape 11 having no adhesive layer on the inner side can be wound. In that case, the adhesive layer 5 may be provided on the outer side of the first insulating tape 11 and the inner side of the second insulating tape 12, or the adhesive layer 5 may be provided on either the outer side of the first insulating tape 11 or the inner side of the second insulating tape 12. The third insulating tape 13 having the adhesive layer 5 provided on one side is wound on the second insulating layer 2b such that the adhesive layer 5 is on the inner side. The fourth insulating tape 14 and the fifth insulating tape 15 having the adhesive layer 5 provided on one side are also wound such that the adhesive layer 5 is on the inner side.

In order to reduce the outer diameter of the insulated wire 10, an insulating tape having no adhesive layer can be used as any one of the two to five insulating tapes other than the fifth insulating tape. For example, when the first insulating tape 11 has no adhesive layer 5, the second to fifth insulating tapes are wound with the adhesive layer on the inner side. When the second insulating tape 12 has no adhesive layer 5, the first insulating tape 11 is wound with the adhesive layer 5 on the outer side, and the third to fifth insulating tapes are wound with the adhesive layer 5 on the inner side. Similarly, when the third insulating tape 13 or the fourth insulating tape 14 has no adhesive layer 5, the inner insulating tape of the insulating layer having no adhesive layer 5 is wound with the adhesive layer 5 on the outer side, and the outer insulating tape of the insulating layer having no adhesive layer 5 is wound with the adhesive layer 5 on the inner side. In this way, a strong insulating coating 2 can be formed.

In order to further reduce the outer diameter of the insulated wire 10 and to maintain the shape of the insulating layer, an insulating tape in which the adhesive layer 5 is provided on the inner side of the insulating tape serving as the outermost layer can be used. Thereby, the adhesive layer of the other insulating layers (layers other than the outermost layer; for example, in the case of five-layer winding, this means a case where the adhesive layer is provided on the fifth layer and not on the first to fourth layers) can be eliminated, and an insulating coating having flexibility can be formed.

Preferable examples of the material of the adhesive layer 5 include a thermoplastic resin such as acrylic, polyester, urethane, polyimide, PVC, or EVA, and a thermosetting resin such as epoxy or bismaleimide. The adhesive layer 5 can be formed by applying an adhesive paint obtained by dissolving these resins in an organic solvent to a predetermined thickness with a coating apparatus such as gravure printing. The adhesive layer 5 can be adhered by heating or the like when the insulating tape is wound on the conductor 1 or after winding.

### (Fusion Layer)

As shown in FIG. 4B, the fusion layer 6 may be provided on any one or more of the two to five insulating tapes as necessary. The fusion layer 6 may be provided in place of the adhesive layer 5 described above. Usually, a resin tape 4 with the fusion layer 6 in which the fusion layer 6 is provided on the resin tape 4 made of the materials described in the section of the materials of the insulating tape above can be employed. The fusion layer 6 is preferably provided outwardly on the insulating tape wound last among the plurality of insulating tapes. By doing so, when manufacturing a coil with the obtained tape-wrapped insulated wire 10, the fusion layer 6 can be melted to fix the insulated wires together.

The material of the fusion layer 6 is preferably a thermoplastic resin composition or a resin composition mainly composed of a thermoplastic resin, and is preferably one having a property of being able to temporarily adhere insulating tapes to each other while keeping thermoplasticity at a certain temperature, for example, a temperature of 80 to 130 °C, and being able to undergo a crosslinking reaction at a specific temperature or higher, for example, a temperature of 160 to 200 °C, to self-fuse and adhere insulated wires 10, 10 to each other. With the fusion layer 6 having such a property, the insulating tapes can be temporarily adhered to each other to maintain the shape as a self-fusible tape-wrapped insulated wire, and after coil winding during manufacture of the coil, the temperature can be raised to a specific temperature or higher to cause a crosslinking reaction to occur and self-fuse the self-fusible insulated wires to each other, so that the coil shape after winding can be maintained.

Examples of the material of the fusion layer 6 include thermosetting resins such as a polyurethane resin, a polyamide resin, a polyester resin, and a polyester-imide resin. Among these, a polyurethane resin and a polyester resin are preferable. The fusion-layer-forming resin composition that forms the fusion layer 6 contains a crosslinking agent and a solvent. Various additives are also contained as necessary. These crosslinking agents, solvents, and additives are not particularly limited, and various crosslinking agents, solvents, and additives are used as necessary depending on the kind and required characteristics (the property described above) of the polyurethane resin, polyester resin, polyester-imide resin, or the like. The thickness of the fusion layer 6 is not particularly limited, but if it is too thick, the outer diameter of the insulated wire 10 increases; therefore, the thickness is preferably, for example, in the range of 1 to 15 μm.

### [Coil]

As shown in FIG. 5, the coil 20 according to the present invention is a transformer coil using the insulated wire 10 according to the present invention described above, and can be obtained by winding the insulated wire 10 on a transformer bobbin 21. Since the coil 20 obtained in this way is wound with the tape-wrapped insulated wire 10 described above, the electrical breakdown voltage is maintained or improved, the productivity is high, and the coil can be a small-sized coil with a high space factor. In addition, a high-withstand-voltage transformer satisfying the IEC62368 standard can be manufactured without winding interlayer paper between the primary winding and the secondary winding as in the conventional art. As a result, the coil can be preferably used as a highly insulating transformer coil, a winding component such as a high-frequency coil, a circuit board provided with a winding component such as a high-frequency coil, or the like.

### EXAMPLES

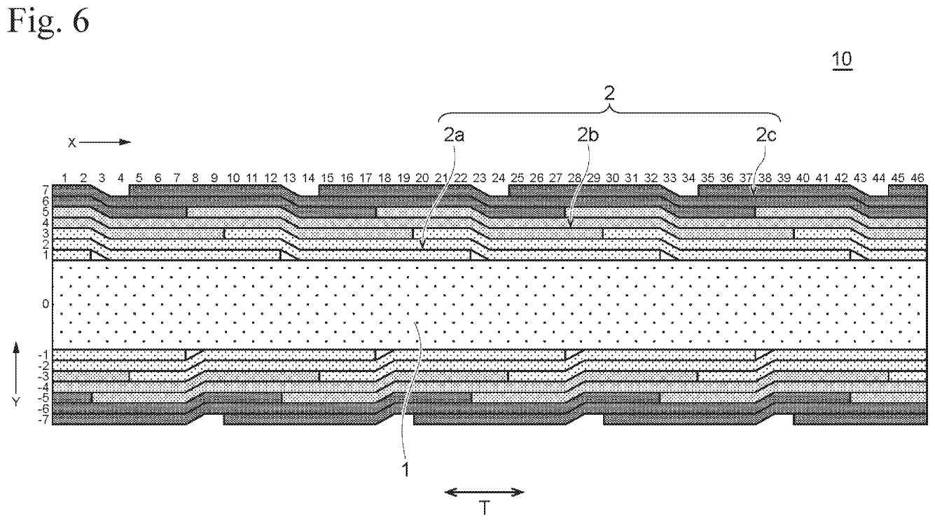

The present invention will be described more specifically by way of Examples and Comparative Examples. The present invention is not limited to the following Examples, and a person skilled in the art can make various changes, modifications, and alterations within the scope of the present invention. In FIGS. 6 to 9 illustrating the embodiments of the Examples and Comparative Examples, coordinates are attached vertically and horizontally to make it easy to understand where the ends of the insulating tapes are located. The coordinates are expressed as (x, y), where “x” is the numerical value of the horizontal coordinate and “y” is the numerical value of the vertical coordinate.

### Example 1

The tape-wrapped insulated wire 10 of Example 1 will be described with reference to FIG. 6. A copper conductor having a diameter of 1.00 mm was used as the conductor 1, and the insulating coating 2 was provided on the outer periphery thereof. The insulating coating 2 was composed of three insulating layers (2a, 2b, 2c) formed by overlap-winding the first to third insulating tapes (11, 12, 13). The first insulating layer 2a closest to the conductor 1 was formed by overlap-winding the first insulating tape 11; the second insulating layer 2b on the outer side thereof was formed by overlap-winding the second insulating tape 12; and the third insulating layer 2c on the outer side thereof was formed by overlap-winding the third insulating tape 13.

A first insulating tape 11 made of polyimide resin and having a thickness of 7.5 μm with an adhesive layer of 2 μm thickness (total thickness 9.5 μm) and a tape width of 7.0 mm was wound on the conductor 1 in 2.3-fold winding, with the adhesive layer on the outer side so as not to adhere to the conductor 1, to provide the first insulating layer 2a. From the coordinates in FIG. 6, the coordinates of the ends of the first insulating tape 11 forming the first insulating layer 2a are (10, 3) and (32, 1); the coordinates of the ends of the first insulating tape 11 when wound a half turn are (15, −3) and (37, −1); and the coordinates of the ends of the first insulating tape 11 when wound a further half turn are (20, 3) and (42, 1). Since the first insulating layer 2a is a layer wound in 2.3-fold winding, on the upper side of the conductor 1 shown in FIG. 6, x-coordinates 1 to 2, 10 to 12, 20 to 22, 30 to 32, and 40 to 42 are 3-fold wound, and the other portions are 2-fold wound. On the lower side of the conductor 1, x-coordinates 5 to 7, 15 to 17, 25 to 27, 35 to 37, and 45 to 46 are 3-fold wound, and the other portions are 2-fold wound.

Next, a second insulating tape 12 made of polyimide resin and having a thickness of 7.5 μm with an adhesive layer of 2 μm thickness (total thickness 9.5 μm) and a tape width of 7.0 mm was wound on the first insulating layer 2a in 2.2-fold winding, with the adhesive layer on the inner side so as to adhere to the first insulating layer 2a and with the winding direction changed from that of the first insulating tape 11, to provide the second insulating layer 2b. In FIG. 6, the state in which the second insulating tape 12 is along the end of the first insulating layer 2a can be seen. The coordinates of the ends of the second insulating tape 12 forming the second insulating layer 2b are (8, 5) and (29, 3); the coordinates of the ends of the second insulating tape 12 when wound a half turn are (13, −5) and (34, −3); and the coordinates of the ends of the second insulating tape 12 when wound a further half turn are (18, 5) and (39, 3). Since the second insulating layer 2b is a layer wound in 2.2-fold winding, on the upper side of the conductor 1 shown in FIG. 6, x-coordinates 8 to 9, 18 to 19, 28 to 29, and 38 to 39 are 3-fold wound, and the other portions are 2-fold wound. On the lower side of the conductor 1, x-coordinates 3 to 4, 13 to 14, 23 to 24, 33 to 34, and 43 to 44 are 3-fold wound, and the other portions are 2-fold wound.

Next, a third insulating tape 13 made of polyimide resin and having a thickness of 7.5 μm with an adhesive layer of 2 μm thickness (total thickness 9.5 μm) and a tape width of 7.5 mm was wound on the second insulating layer 2b in 2.3-fold winding, with the adhesive layer on the inner side so as to adhere to the second insulating layer 2b and with the winding direction changed from that of the second insulating tape 12, to provide the third insulating layer 2c. In FIG. 6, the state in which the third insulating tape 13 is along the end of the second insulating layer 2b can be seen. The coordinates of the ends of the third insulating tape 13 forming the third insulating layer 2c are (5, 7) and (27, 5); the coordinates of the ends of the third insulating tape 13 when wound a half turn are (10, −7) and (32, −5); and the coordinates of the ends of the third insulating tape 13 when wound a further half turn are (15, 7) and (37, 5). Therefore, since the third insulating layer 2c is wound in 2.3-fold winding, on the upper side of the conductor 1 shown in FIG. 6, x-coordinates 5 to 7, 15 to 17, 25 to 27, 35 to 37, and 45 to 46 are 3-fold wound, and the other portions are 2-fold wound. On the lower side of the conductor 1, x-coordinates 1 to 2, 10 to 12, 20 to 22, 30 to 32, and 40 to 42 are 3-fold wound, and the other portions are 2-fold wound. In this way, the tape-wrapped insulated wire of Example 1 was obtained.

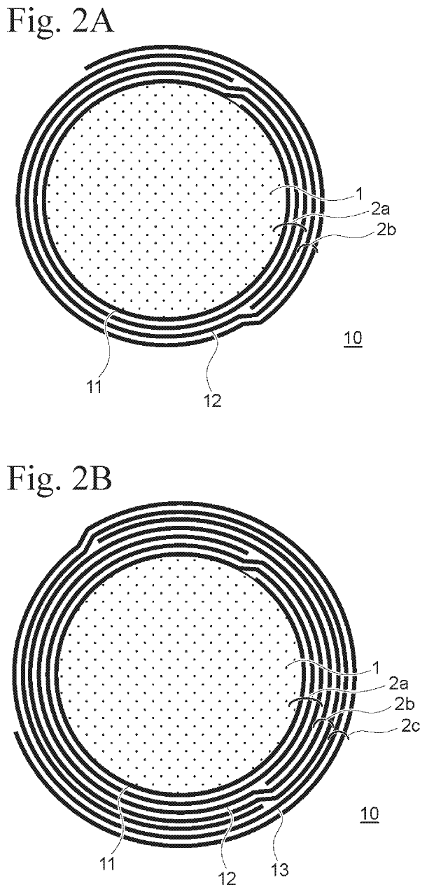

In the obtained tape-wrapped insulated wire, the average thickness at each portion in the longitudinal direction T of the insulating coating 2 having the first insulating layer 2a, the second insulating layer 2b, and the third insulating layer 2c was 64 μm. The sum of the integer parts of the winding counts (minimum winding count) of the first insulating layer 2a, the second insulating layer 2b, and the third insulating layer 2c was 2+2+2=6, the winding counts of the fractional parts were all 0.5 or less, and the sum of the fractional parts was 0.8, which is 1.0 or less. The total winding count obtained by adding these together was 6.8, which is 7 or less, the total number obtained by adding 1 to the sum of the integer parts. The winding count of each insulating layer can be seen from FIG. 2B. Reference numeral 1 denotes the conductor, around which the first insulating tape 11 is wound clockwise in 2.3-fold winding. The second insulating tape 12 is wound counterclockwise in 2.2-fold winding on the outer side thereof, and the third insulating tape 13 is wound clockwise in 2.3-fold winding on the outer side thereof.

### Comparative Example 1

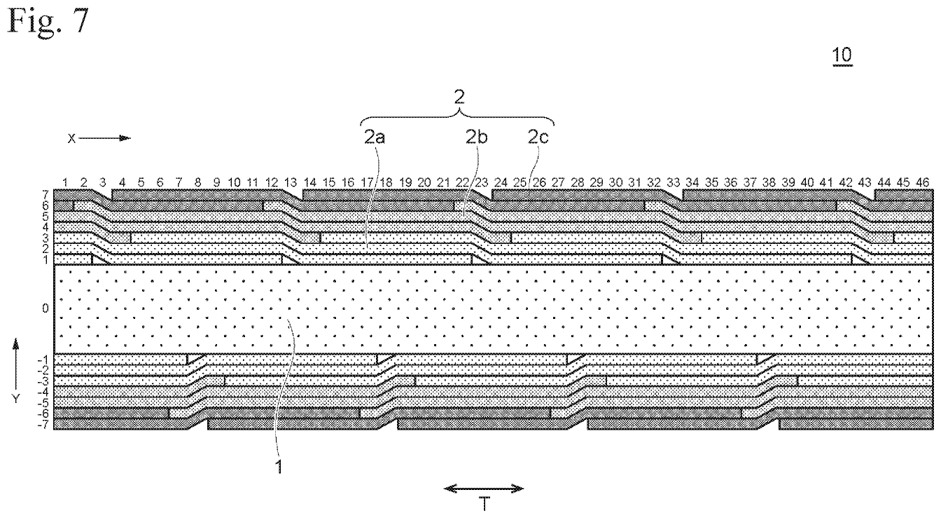

The tape-wrapped insulated wire 10 of Comparative Example 1 will be described with reference to FIG. 7. A copper wire having a diameter of 1.00 mm was used as the conductor 1, and the insulating coating 2 provided on the outer periphery thereof was composed of three insulating layers (2a, 2b, 2c) overlap-wound with the first to third insulating tapes (11, 12, 13). A first insulating tape 11 made of polyimide resin and having a thickness of 7.5 μm with an adhesive layer of 2 μm thickness (total thickness 9.5 μm) and a tape width of 8.5 mm was wound on the conductor 1 in 2.8-fold winding, with the adhesive layer on the outer side so as not to adhere to the conductor 1, to provide the first insulating layer 2a. Next, a second insulating tape 12 made of polyimide resin and having a thickness of 7.5 μm with an adhesive layer of 2 μm thickness (total thickness 9.5 μm) and a tape width of 7.5 mm was wound on the first insulating layer 2a in 2.3-fold winding, with the adhesive on the inner side so as to adhere to the first insulating layer 2a and with the winding direction changed from that of the first insulating tape 11, to provide the second insulating layer 2b. Next, a third insulating tape 13 made of polyimide resin and having a thickness of 7.5 μm with an adhesive layer of 2 μm thickness (total thickness 9.5 μm) and a tape width of 6.0 mm was wound on the second insulating layer 2b in 1.8-fold winding, with the adhesive layer on the inner side so as to adhere to the second insulating layer 2b and with the winding direction changed from that of the second insulating tape 12, to provide the third insulating layer 2c. In this way, the tape-wrapped insulated wire of Comparative Example 1 was obtained.

In the obtained tape-wrapped insulated wire, the average thickness at each portion in the longitudinal direction T of the insulating coating 2 having the first insulating layer 2a, the second insulating layer 2b, and the third insulating layer 2c was 64 μm. The sum of the integer parts of the winding counts (minimum winding count) of the first insulating layer 2a, the second insulating layer 2b, and the third insulating layer 2c was 2+2+1=5, and the sum of the winding counts of the fractional parts was 1.9, which exceeded 1.0. The total winding count obtained by adding these together was 6.9, which exceeded 6, the total number obtained by adding 1 to the sum of the integer parts.

### Example 2

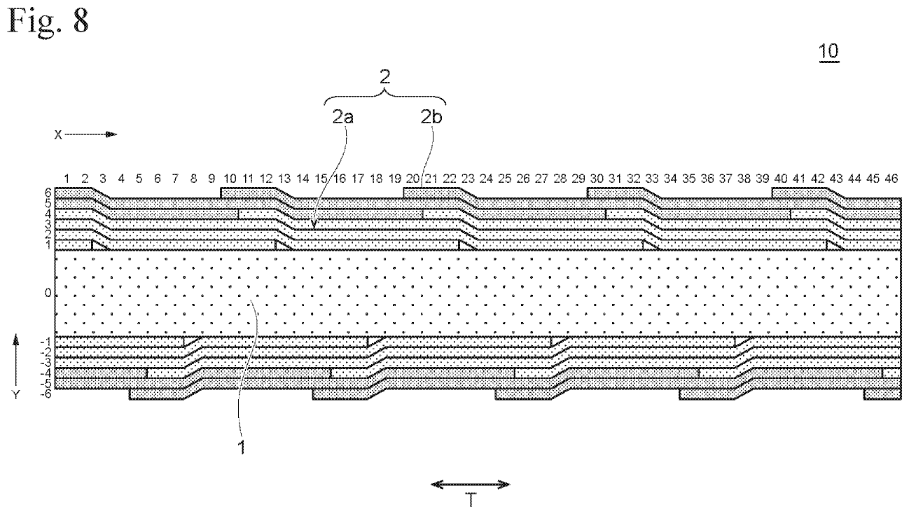

The tape-wrapped insulated wire 10 of Example 2 will be described with reference to FIG. 8. A copper conductor having a diameter of 0.55 mm was used as the conductor 1, and the insulating coating 2 provided on the outer periphery thereof was composed of two insulating layers (2a, 2b) overlap-wound with the first insulating tape 11 and the second insulating tape 12. A first insulating tape 11 made of polyimide resin and having a thickness of 7.5 μm with an adhesive layer of 2 μm thickness (total thickness 9.5 μm) and a tape width of 5.5 mm was wound on the conductor 1 in 3.2-fold winding, with the adhesive layer on the outer side so as not to adhere to the conductor 1, to provide the first insulating layer 2a. Next, a second insulating tape 12 made of polyimide resin and having a thickness of 7.5 μm with an adhesive layer of 2 μm thickness (total thickness 9.5 μm) and a tape width of 4.0 mm was wound on the first insulating layer 2a in 2.1-fold winding, with the adhesive on the inner side so as to adhere to the first insulating layer 2a and with the winding direction changed from that of the first insulating tape 11, to provide the second insulating layer 2b. The third insulating layer was not provided. In this way, the tape-wrapped insulated wire of Example 2 was obtained.

In the obtained tape-wrapped insulated wire, the average thickness at each portion in the longitudinal direction T of the insulating coating 2 having the first insulating layer 2a and the second insulating layer 2b was 48 μm. The sum of the integer parts of the winding counts (minimum winding count) of the first insulating layer 2a and the second insulating layer 2b was 3+2=5, the winding counts of the fractional parts were all 0.5 or less, and the sum of the fractional parts was 0.3, which is 1.0 or less. The total winding count obtained by adding these together was 5.3, which is 6 or less, the total number obtained by adding 1 to the sum of the integer parts.

### Comparative Example 2

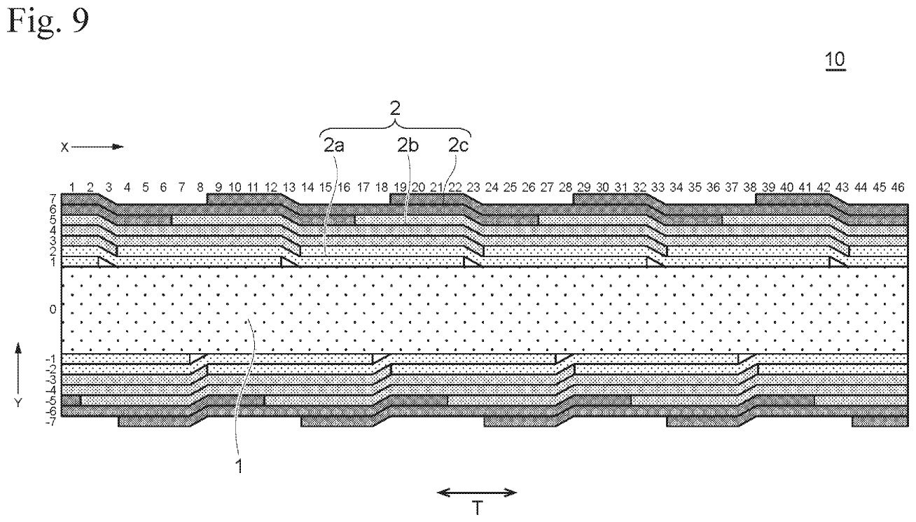

The tape-wrapped insulated wire 10 of Comparative Example 2 will be described with reference to FIG. 9. A copper wire having a diameter of 0.55 mm was used as the conductor 1, and the insulating coating 2 provided on the outer periphery thereof was composed of three insulating layers (2a, 2b, 2c) overlap-wound with the first to third insulating tapes (11, 12, 13). A first insulating tape 11 made of polyimide resin and having a thickness of 7.5 μm with an adhesive layer of 2 μm thickness (total thickness 9.5 μm) and a tape width of 3.0 mm was wound on the conductor 1 in 1.9-fold winding, with the adhesive layer on the outer side so as not to adhere to the conductor 1, to provide the first insulating layer 2a. Next, a second insulating tape 12 made of polyimide resin and having a thickness of 7.5 μm with an adhesive layer of 2 μm thickness (total thickness 9.5 μm) and a tape width of 5.0 mm was wound on the first insulating layer 2a in 2.7-fold winding, with the adhesive on the inner side so as to adhere to the first insulating layer 2a and with the winding direction changed from that of the first insulating tape 11, to provide the second insulating layer 2b. Next, a third insulating tape 13 made of polyimide resin and having a thickness of 7.5 μm with an adhesive layer of 2 μm thickness (total thickness 9.5 μm) and a tape width of 3.5 mm was wound on the second insulating layer 2b in 1.8-fold winding, with the adhesive layer on the inner side so as to adhere to the second insulating layer 2b and with the winding direction changed from that of the second insulating tape 12, to provide the third insulating layer 2c. In this way, the tape-wrapped insulated wire of Comparative Example 2 was obtained.

In the obtained tape-wrapped insulated wire, the average thickness at each portion in the longitudinal direction T of the insulating coating 2 having the first insulating layer 2a, the second insulating layer 2b, and the third insulating layer 2c was 57 μm. The sum of the integer parts of the winding counts (minimum winding count) of the first insulating layer 2a, the second insulating layer 2b, and the third insulating layer 2c was 1+2+1=4, the winding counts of the fractional parts all exceeded 0.5, and the sum of the fractional parts was 2.4, which exceeded 1.0. The total winding count obtained by adding these together was 6.4, which exceeded 5, the total number obtained by adding 1 to the sum of the integer parts.

### Example 3

A litz wire formed by twisting 33 copper wires having a diameter of 0.1 mm was used as the conductor 1, and the insulating coating 2 provided on the outer periphery thereof was composed of two insulating layers (2a, 2b) overlap-wound with the first insulating tape 11 and the second insulating tape 12. A first insulating tape 11 made of polyimide resin and having a thickness of 7.5 μm with an adhesive layer of 2 μm thickness (total thickness 9.5 μm) and a tape width of 6.5 mm was wound on the conductor 1 in 3.2-fold winding, with the adhesive layer on the outer side so as not to adhere to the conductor 1, to provide the first insulating layer 2a. Next, a second insulating tape 12 made of polyimide resin and having a thickness of 7.5 μm with an adhesive layer of 2 μm thickness (total thickness 9.5 μm) and a tape width of 7.0 mm was wound on the first insulating layer 2a in 3.1-fold winding, with the adhesive on the inner side so as to adhere to the first insulating layer 2a and with the winding direction changed from that of the first insulating tape 11, to provide the second insulating layer 2b. The third insulating layer was not provided. In this way, the tape-wrapped insulated wire of Example 3 was obtained.

In the obtained tape-wrapped insulated wire, the average thickness at each portion in the longitudinal direction T of the insulating coating 2 having the first insulating layer 2a and the second insulating layer 2b was 63 μm. The sum of the integer parts of the winding counts (minimum winding count) of the first insulating layer 2a and the second insulating layer 2b was 3+3=6, the winding counts of the fractional parts were all 0.5 or less, and the sum thereof was 0.3, which is 1.0 or less. The total winding count obtained by adding these together was 6.3, which is 7 or less, the total number obtained by adding 1 to the sum of the integer parts.

### Example 4

A copper wire having a diameter of 0.45 mm was used as the conductor 1, and the insulating coating 2 provided on the outer periphery thereof was composed of two insulating layers (2a, 2b) overlap-wound with the first insulating tape 11 and the second insulating tape 12. A first insulating tape 11 made of polyimide resin and having a thickness of 5.0 μm with an adhesive layer of 2.5 μm thickness (total thickness 7.5 μm) and a tape width of 4.8 mm was wound on the conductor 1 in 3.4-fold winding, with the adhesive layer on the outer side so as not to adhere to the conductor 1, to provide the first insulating layer 2a. Next, a second insulating tape 12 made of polyimide resin and having a thickness of 5.0 μm with an adhesive layer of 2.5 μm thickness (total thickness 7.5 μm) and a tape width of 4.8 mm was wound on the first insulating layer 2a in 3.1-fold winding, with the adhesive on the inner side so as to adhere to the first insulating layer 2a and with the winding direction changed from that of the first insulating tape 11, to provide the second insulating layer 2b. The third insulating layer was not provided. In this way, the tape-wrapped insulated wire of Example 4 was obtained.

In the obtained tape-wrapped insulated wire, the average thickness at each portion in the longitudinal direction T of the insulating coating 2 having the first insulating layer 2a and the second insulating layer 2b was 51 μm. The sum of the integer parts of the winding counts (minimum winding count) of the first insulating layer 2a and the second insulating layer 2b was 3+3=6, the winding counts of the fractional parts were all 0.5 or less, and the sum thereof was 0.5, which is 1.0 or less. The total winding count obtained by adding these together was 6.5, which is 7 or less, the total number obtained by adding 1 to the sum of the integer parts.

### [Inter-Wire Withstand Voltage Test]

For Examples 1 to 4 and Comparative Examples 1 to 2, samples in which two tape-wrapped insulated wires were twisted together were prepared, and after applying 8 kV for 1 minute as specified in the reinforced insulation test, the test voltage was applied between the conductors at a voltage rise rate of 500 V/s, and the electrical breakdown voltage was measured. The measurement was performed with a withstand voltage tester (manufactured by Tokyo Seiden Co., Ltd.) based on JIS C 3216 (winding test method). The results are shown in Table 1. In Table 1, “Tape Thickness” is the thickness of the insulating tape not including the thickness of the adhesive layer, “Tape Total Thickness” is the total thickness of the insulating tape including the thickness of the adhesive layer, “Integer” is the sum of the integer parts in each insulating layer (minimum winding count), “Fractional” is the sum of the fractional parts in each insulating layer, “Total” is the sum of “Integer” and “Fractional”, and “Coating Thickness” is the thickness of the entire insulating coating including the first to third layers.

TABLE 1

| | | Tape | | | | | | | | Electrical |
|---|---|---|---|---|---|---|---|---|---|---|
| | Tape | Total | Winding Count of Each Insulating Layer | | | | | | Coating | Breakdown |
| | Thickness | Thickness | 1st | 2nd | 3rd | | | | Thickness | Voltage |
| | [μm] | [μm] | Layer | Layer | Layer | Integer | Fractional | Total | [μm] | [kV] |
| Example 1 | 7.5 | 9.5 | 2.3 | 2.2 | 2.3 | 6 | 0.8 | 6.8 | 64 | 16.95 |
| Comparative | 7.5 | 9.5 | 2.8 | 2.3 | 1.8 | 5 | 1.9 | 6.9 | 64 | 15.57 |
| Example 1 | | | | | | | | | | |
| Example 2 | 7.5 | 9.5 | 3.2 | 2.1 | — | 5 | 0.3 | 5.3 | 48 | 21.30 |
| Comparative | 7.5 | 9.5 | 1.9 | 2.7 | 1.8 | 4 | 2.4 | 6.4 | 57 | 16.31 |
| Example 2 | | | | | | | | | | |
| Example 3 | 7.5 | 9.5 | 3.2 | 3.1 | — | 6 | 0.3 | 6.3 | 63 | 21.50 |
| Example 4 | 5.0 | 7.5 | 3.4 | 3.1 | — | 6 | 0.5 | 6.5 | 51 | 22.86 |

The electrical breakdown voltage in Example 1 was 16.95 kV, which is 1.38 kV higher than 15.57 kV in Comparative Example 1. Both have the insulating coating 2 composed of the same first to third insulating layers (2a, 2b, 2c), the thickness of the insulating coating 2 is the same, and the total number (sum of the integer parts and the fractional parts) is also the same; however, in Example 1, the fractional part is 0.8, which is 1.0 or less, whereas in Comparative Example 1, the fractional part is 1.9, which exceeds 1.0. Since the sum of the integer parts on which the electrical breakdown voltage depends (minimum winding count) is greater in Example 1, the electrical breakdown voltage of Example 1 is higher than that of Comparative Example 1. From the results of Example 2 and Comparative Example 2, it can be seen that, even when the coating thickness and the total number (sum of the integer parts and the fractional parts) are the same, a high electrical breakdown voltage can be obtained by setting the sum of the fractional parts to 1.0 or less and increasing the sum of the integer parts.

The electrical breakdown voltage was 21.30 kV in Example 2, which is 4.99 kV higher than 16.31 kV in Comparative Example 2. The thickness of the insulating coating 2 is 48 μm in Example 2 and 57 μm in Comparative Example 2; despite Example 2 being 9 μm thinner than Comparative Example 2, the electrical breakdown voltage is 4.99 kV higher because the sum of the integer parts on which the electrical breakdown voltage depends (minimum winding count) is 5 in Example 2, which is greater than 4 in Comparative Example 2. From the results of Example 2 and Comparative Example 2, it can be seen that, by setting the sum of the fractional parts to 1.0 or less and increasing the sum of the integer parts, a sufficient electrical breakdown voltage can be obtained even when the coating thickness is reduced.

The electrical breakdown voltage was 21.5 kV in Example 3 and 22.86 kV in Example 4. In each of these, the sum of the fractional parts was set to 1.0 or less and the sum of the integer parts was increased, and it can be seen that a sufficient electrical breakdown voltage can be obtained. Furthermore, in Example 4, the thickness of the insulating tape was reduced to make the total thickness of the insulating coating 2 thinner; even in such a case, a sufficient electrical breakdown voltage can be obtained by setting the sum of the fractional parts to 1.0 or less and increasing the sum of the integer parts.

### Examples 5 to 11

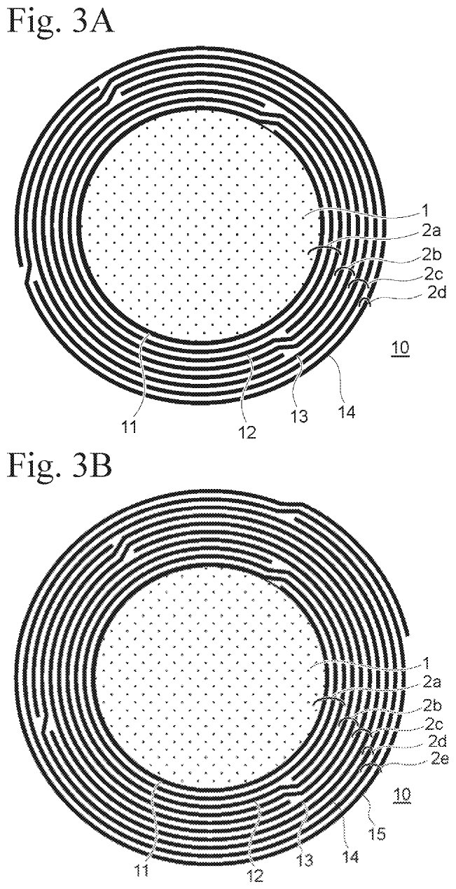

Two to five insulating tapes the same as the first insulating tape 11 of Example 1 were used arbitrarily, and the winding counts of the respective insulating layers overlap-wound with the respective insulating tapes were changed. Other than that, the insulated wires 10 of Examples 5 to 11 in the forms shown in FIGS. 2 and 3 were prepared in the same manner as in Example 1. Table 2 shows the winding counts of the respective insulating layers. In Table 2, “Integer Component” is the sum of the integer parts in each insulating layer, “Fractional Component” is the sum of the fractional parts in each insulating layer, and “Total” is the sum of the sum of the integer parts and the sum of the fractional parts.

The insulated wire 10 of Example 5 was obtained by setting the first insulating tape 11 to 4.3-fold winding to form the first insulating layer 2a, and on top thereof setting the second insulating tape 12 to 4.2-fold winding to form the second insulating layer 2b. The sum of the integer parts was 8, the sum of the fractional parts was 0.5, and the total thereof was 8.5.

The insulated wire 10 of Example 6 was obtained by setting the first insulating tape 11 to 1.5-fold winding to form the first insulating layer 2a, and on top thereof setting the second insulating tape 12 to 1.4-fold winding to form the second insulating layer 2b. The sum of the integer parts was 2, the sum of the fractional parts was 0.9, and the total thereof was 2.9.

The insulated wire 10 of Example 7 was obtained by setting the first insulating tape 11 to 3.3-fold winding to form the first insulating layer 2a, on top thereof setting the second insulating tape 12 to 3.2-fold winding to form the second insulating layer 2b, and on top thereof setting the third insulating tape 13 to 3.3-fold winding to form the third insulating layer 2c. The sum of the integer parts was 9, the sum of the fractional parts was 0.8, and the total thereof was 9.8.

The insulated wire 10 of Example 8 was obtained by setting the first insulating tape 11 to 4.2-fold winding to form the first insulating layer 2a, on top thereof setting the second insulating tape 12 to 4.4-fold winding to form the second insulating layer 2b, on top thereof setting the third insulating tape 13 to 3.3-fold winding to form the third insulating layer 2c, and on top thereof setting the fourth insulating tape 14 to 3.4-fold winding to form the fourth insulating layer 2d. The sum of the integer parts was 14, the sum of the fractional parts was 1.3, and the total thereof was 15.3.

The insulated wire 10 of Example 9 was obtained by setting the first insulating tape 11 to 2.3-fold winding to form the first insulating layer 2a, on top thereof setting the second insulating tape 12 to 2.4-fold winding to form the second insulating layer 2b, on top thereof setting the third insulating tape 13 to 1.3-fold winding to form the third insulating layer 2c, and on top thereof setting the fourth insulating tape 14 to 1.4-fold winding to form the fourth insulating layer 2d. The sum of the integer parts was 6, the sum of the fractional parts was 1.4, and the total thereof was 7.4.

The insulated wire 10 of Example 10 was obtained by setting the first insulating tape 11 to 2.3-fold winding to form the first insulating layer 2a, on top thereof setting the second insulating tape 12 to 2.2-fold winding to form the second insulating layer 2b, on top thereof setting the third insulating tape 13 to 2.3-fold winding to form the third insulating layer 2c, on top thereof setting the fourth insulating tape 14 to 2.4-fold winding to form the fourth insulating layer 2d, and on top thereof setting the fifth insulating tape 15 to 2.2-fold winding to form the fifth insulating layer 2e. The sum of the integer parts was 10, the sum of the fractional parts was 1.4, and the total thereof was 11.4.

The insulated wire 10 of Example 11 was obtained by setting the first insulating tape 11 to 2.3-fold winding to form the first insulating layer 2a, on top thereof setting the second insulating tape 12 to 1.3-fold winding to form the second insulating layer 2b, on top thereof setting the third insulating tape 13 to 1.3-fold winding to form the third insulating layer 2c, on top thereof setting the fourth insulating tape 14 to 1.4-fold winding to form the fourth insulating layer 2d, and on top thereof setting the fifth insulating tape 15 to 2.3-fold winding to form the fifth insulating layer 2e. The sum of the integer parts was 7, the sum of the fractional parts was 1.7, and the total thereof was 8.7.

TABLE 2

| | 1st | 2nd | 3rd | 4th | 5th | Integer | Fractional | |
|---|---|---|---|---|---|---|---|---|
| | Layer | Layer | Layer | Layer | Layer | Component | Component | Total |
| Example 5 | 4.3 | 4.2 | — | — | — | 8 | 0.5 | 8.5 |
| Example 6 | 1.5 | 1.4 | — | — | — | 2 | 0.9 | 2.9 |
| Example 7 | 3.3 | 3.2 | 3.3 | — | — | 9 | 0.8 | 9.8 |
| Example 8 | 4.2 | 4.4 | 3.3 | 3.4 | — | 14 | 1.3 | 15.3 |
| Example 9 | 2.3 | 2.4 | 1.3 | 1.4 | — | 6 | 1.4 | 7.4 |
| Example 10 | 2.3 | 2.2 | 2.3 | 2.4 | 2.2 | 10 | 1.4 | 11.4 |
| Example 11 | 2.3 | 1.3 | 1.4 | 1.4 | 2.3 | 7 | 1.7 | 8.7 |
| Example 12 | 2.3 | 2.2 | 2.1 | — | — | 6 | 0.6 | 6.6 |
| Example 13 | 3.5 | 3.3 | 3.1 | — | — | 9 | 0.9 | 9.9 |
| Example 14 | 2.4 | 2.5 | 2.4 | — | — | 6 | 1.3 | 7.3 |
| Example 15 | 2.4 | 1.5 | 2.4 | — | — | 5 | 1.3 | 6.3 |

From the results of Table 2, two to five insulating tapes can be arbitrarily adopted, and the winding counts overlap-wound with the respective insulating tapes can be arbitrarily designed so as to constitute the tape-wrapped insulated wire according to the present invention. By doing so, the effects of the present invention described above can be realized with a high degree of design freedom.

### Example 12

Insulating tapes the same as the first insulating tape 11 and the second insulating tape 12 used in Example 1 were used, and the winding counts of the first to third layers overlap-wound with the respective insulating tapes were changed as shown in Table 2. Other than that, the insulated wire of Example 12 was prepared in the same manner as in Example 1. In this insulated wire, the integer parts of the first to third layers were made the same, and the fractional parts were sequentially made smaller from the first layer to the third layer to eliminate the occurrence of steps and further enhance flatness. The sum of the integer parts was 6, the sum of the fractional parts was 0.6, and the total thereof was 6.6.

### Example 13

As the first insulating tape 11, one made of polyimide resin and having a thickness of 7.5 μm with an adhesive layer of 2 μm thickness (total thickness 9.5 μm) and a tape width of 10.5 mm was used; as the second insulating tape 12, one made of polyimide resin and having a thickness of 7.5 μm with an adhesive layer of 2 μm thickness (total thickness 9.5 μm) and a tape width of 10.5 mm was also used; and as the third insulating tape 13, one made of polyimide resin and having a thickness of 7.5 μm with an adhesive layer of 2 μm thickness (total thickness 9.5 μm) and a tape width of 10.5 mm was also used. The winding counts of the first to third layers overlap-wound with the respective insulating tapes were changed as shown in Table 2. Other than that, the insulated wire of Example 13 was prepared in the same manner as in Example 1. In this insulated wire, the integer parts of the first to third layers were made the same to enhance the ease of manufacture, and the fractional parts were sequentially made smaller from the first layer to the third layer to eliminate the occurrence of steps and further enhance flatness. The sum of the integer parts was 9, the sum of the fractional parts was 0.9, and the total thereof was 9.9.

### Example 14

As the first insulating tape 11, one made of polyimide resin and having a thickness of 7.5 μm with an adhesive layer of 2 μm thickness (total thickness 9.5 μm) and a tape width of 6.0 mm was used; as the second insulating tape 12, one made of polyimide resin and having a thickness of 7.5 μm with an adhesive layer of 2 μm thickness (total thickness 9.5 μm) and a tape width of 6.5 mm was used; and as the third insulating tape 13, one made of polyimide resin and having a thickness of 7.5 μm with an adhesive layer of 2 μm thickness (total thickness 9.5 μm) and a tape width of 6.5 mm was used. A copper conductor having a diameter of 0.80 mm was used as the conductor 1, and the winding counts of the first to third layers overlap-wound with the respective insulating tapes on the outer periphery thereof were as shown in Table 2. Other than that, the insulated wire of Example 14 was prepared in the same manner as in Example 1. In this insulated wire, the integer parts of the first to third layers were made the same to enhance the ease of manufacture, and the fractional parts of the first to third layers were each 0.5 or less, with the sum of the fractional parts being 1.3, which is 1.5 or less. The sum of the integer parts was 6, the sum of the fractional parts was 1.3, and the total thereof was 7.3. In such an insulated wire of Example 14, although the sum of the fractional parts is 1.3, the same effects as in the case of being set to 1.0 or less (the total thickness of the insulating layers can be reduced, the insulated wire can also be made thinner, the electrical breakdown voltage can be maintained or improved, the wire is flexible and excellent in coil-winding properties, and the space factor can be increased to miniaturize the coil) can be maintained.

### Example 15

As the first insulating tape 11, one made of polyimide resin and having a thickness of 7.5 μm with an adhesive layer of 2 μm thickness (total thickness 9.5 μm) and a tape width of 4.5 mm was used; as the second insulating tape 12, one made of polyimide resin and having a thickness of 7.5 μm with an adhesive layer of 2 μm thickness (total thickness 9.5 μm) and a tape width of 3.0 mm was used; and as the third insulating tape 13, one made of polyimide resin and having a thickness of 7.5 μm with an adhesive layer of 2 μm thickness (total thickness 9.5 μm) and a tape width of 5.0 mm was used. A copper conductor having a diameter of 0.60 mm was used as the conductor 1, and the winding counts of the first to third layers overlap-wound with the respective insulating tapes on the outer periphery thereof were as shown in Table 2. Other than that, the insulated wire of Example 15 was prepared in the same manner as in Example 1. In this insulated wire, the fractional parts of the first to third layers were each 0.5 or less, with the sum of the fractional parts being 1.3, which is 1.5 or less. The sum of the integer parts was 5, the sum of the fractional parts was 1.3, and the total thereof was 6.3. In such an insulated wire of Example 15, although the sum of the fractional parts is 1.3, the same effects as in the case of being set to 1.0 or less (the total thickness of the insulating layers can be reduced, the insulated wire can also be made thinner, the electrical breakdown voltage can be maintained or improved, the wire is flexible and excellent in coil-winding properties, and the space factor can be increased to miniaturize the coil) can be maintained.

As shown in the above Examples 1 to 15, two to five insulating tapes can be arbitrarily adopted, and the winding counts overlap-wound with the respective insulating tapes can be arbitrarily designed so as to constitute the tape-wrapped insulated wire according to the present invention. By doing so, the effects of the present invention described above can be realized with a high degree of design freedom. In the results of Tables 1 and 2, in any of the cases where the individual insulating layers are two or three layers and where the individual insulating layers are four or five layers, the integer part of the winding count of the individual insulating layers may be in the range of 2 to 4 not including 1, as in Examples 1 to 5, 7, 8, and 10, or the integer part of some layers may be 1 and the integer part of the remaining layers may be 2 to 4, as in Examples 9 and 11.

### DESCRIPTIONS OF REFERENCE NUMERALS

1: Conductor
2: Insulating Coating
2a: First Insulating Layer
2b: Second Insulating Layer
2c: Third Insulating Layer
2d: Fourth Insulating Layer
2e: Fifth Insulating Layer
4: Resin Tape
5: Adhesive Layer
6: Fusion Layer
10: Tape-Wrapped Insulated Wire
11: First Insulating Tape
12: Second Insulating Tape
13: Third Insulating Tape
14: Fourth Insulating Tape
15: Fifth Insulating Tape
20: Coil
21: Transformer Bobbin
T: Longitudinal Direction

What is claimed is:

1. A tape-wrapped insulated wire comprising: a conductor; and an insulating coating provided on an outer periphery of the conductor, wherein the insulating coating is composed of a plurality of insulating layers overlap-wound with two to five insulating tapes, wherein, when the insulating coating includes two individual insulating layers each overlap-wound with a respective one of the insulating tapes, a sum of winding counts of the individual insulating layers is no greater than a total number obtained by adding 1 to a sum of integer parts of the winding counts of the individual insulating layers; when the insulating coating includes three individual insulating layers each overlap-wound with a respective one of the insulating tapes, the sum of the winding counts of the individual insulating layers is no greater than a total number obtained by adding 1.5 to the sum of the integer parts of the winding counts of the individual insulating layers; and when the insulating coating includes four or five individual insulating layers each overlap-wound with a respective one of the insulating tapes, the sum of the winding counts of the individual insulating layers is no greater than a total number obtained by adding 2 to the sum of the integer parts of the winding counts of the individual insulating layers, and wherein, in any of the cases where the individual insulating layers are two to five layers, the integer part of the winding count is in a range of 1 to 4.

2. The tape-wrapped insulated wire according to claim 1, wherein, when the insulating coating includes two or three individual insulating layers each overlap-wound with a respective one of the insulating tapes, and when a winding count of a first insulating tape is expressed as s.α-fold winding, a winding count of a second insulating tape is expressed as t.β-fold winding, and a winding count of a third insulating tape is expressed as u.γ-fold winding, the sum of the integer parts is s+t when the insulating layers are two layers and is s+t+u when the insulating layers are three layers, the sum of the fractional parts is α+β when the insulating layers are two layers and is α+β+γ when the insulating layers are three layers, and the sum of the fractional parts is 1.0 or less.

3. The tape-wrapped insulated wire according to claim 2, wherein, when the insulating tapes are two, the sum of the integer parts is 2 to 8, the sum of the fractional parts is 1.0 or less, and a total number is 2.0 to 9.0, and when the insulating tapes are three, the sum of the integer parts is 3 to 12, the sum of the fractional parts is 1.0 or less, and the total number is 3.0 to 13.0.

4. The tape-wrapped insulated wire according to claim 1, wherein, when the insulating coating includes three individual insulating layers each overlap-wound with a respective one of the insulating tapes, and when a winding count of a first insulating tape is expressed as s.α-fold winding, a winding count of a second insulating tape is expressed as t.β-fold winding, and a winding count of a third insulating tape is expressed as u.γ-fold winding, the sum of the integer parts is s+t+u, the sum of the fractional parts is α+β+γ, and the sum of the fractional parts is 1.5 or less.

5. The tape-wrapped insulated wire according to claim 1, wherein, when the insulating coating includes four or five individual insulating layers each overlap-wound with a respective one of the insulating tapes, and when a winding count of a first insulating tape is expressed as s.α-fold winding, a winding count of a second insulating tape is expressed as t.β-fold winding, a winding count of a third insulating tape is expressed as u.γ-fold winding, a winding count of a fourth insulating tape is expressed as v.δ-fold winding, and a winding count of a fifth insulating tape is expressed as w.ε-fold winding, the sum of the integer parts is s+t+u+v when the insulating layers are four layers and is s+t+u+v+w when the insulating layers are five layers, the sum of the fractional parts is α+β+γ+δ when the insulating layers are four layers and is α+β+γ+δ+ε when the insulating layers are five layers, and the sum of the fractional parts is 2.0 or less.

6. The tape-wrapped insulated wire according to claim 5, wherein, when the insulating tapes are four, the sum of the integer parts is 4 to 16, the sum of the fractional parts is 2.0 or less, and a total number is 4.0 to 18.0, and when the insulating tapes are five, the sum of the integer parts is 5 to 20, the sum of the fractional parts is 2.0 or less, and the total number is 5.0 to 22.0.

7. The tape-wrapped insulated wire according to claim 1, wherein at least one of the two to five insulating tapes has an adhesive layer on one side.

8. The tape-wrapped insulated wire according to claim 1, wherein an insulating tape wound last among the plurality of insulating tapes has a fusion layer on an outwardly facing surface.

9. A coil obtained by winding the tape-wrapped insulated wire according to claim 1.

10. A coil obtained by winding the tape-wrapped insulated wire according to claim 7.

11. A coil obtained by winding the tape-wrapped insulated wire according to claim 8.
